(19) United States
(12) Patent Application Publication
(10) Pub. No.: US 2016/0057431 A1
(43) Pub. Date: Feb. 25, 2016

(54) METHOD AND DEVICE FOR TRANSMITTING A SEQUENCE OF PICTURES, AND CORRESPONDING METHOD AND DEVICE FOR RECEPTION, COMPUTER PROGRAM AND RECORDING MEDIUM

(71) Applicant: ORANGE, Paris (FR)

(72) Inventors: Zaher El Chami, Paris (FR); Thomas Bultel, Paris (FR)

(73) Assignee: ORANGE, Paris (FR)

(21) Appl. No.: 14/650,260

(22) PCT Filed: Dec. 13, 2013
(86) PCT No.: PCT/FR2013/053063

§ 371 Date: Jun. 5, 2015

(30) Foreign Application Priority Data
Dec. 21, 2012 (FR) 1262548

(51) Int. Cl. H04N 19/164; H04N 19/17; H04N 19/167; H04N 19/44; H04N 19/172

(52) U.S. Cl. CPC H04N 19/164; H04N 19/44; H04N 19/172; H04N 19/167; H04N 19/17

(57) ABSTRACT

A method and device for transmitting a sequence of images, and corresponding method and device for receiving same, computer program and recording medium. The invention pertains to a method for transmitting a sequence of images. According to the invention, said method comprises the following steps: identifying (11), in at least one image of said sequence, at least two distinct regions; for each of said regions, determining (12) a coding mode adapted to said region; coding (13) said at least one image using, for each of said regions, the coding mode adapted to said region, and transmission (14) in a single video stream.

### 1. FIELD OF THE INVENTION

The field of the invention is that of the transmission of sequences of pictures, notably within the context of a multimedia session of video conference, video streaming, telesurveillance, etc. type.

More precisely, the invention concerns the maintenance or improvement of the quality of the pictures in a sequence transmitted in such contexts, notably when transmission conditions change.

The invention can be used in all fields requiring the transfer of a sequence of pictures, or video, including within the context of video coding.

### 2. PRIOR ART

When a multimedia session involving a transfer of a sequence of pictures, or video, is set up, the choice of the coder (and of the associated decoder) is made by taking account of several parameters:
the capacities of the transmission channel that carries the video (for example a channel of “IP” type);
the capacities and type of coding that the transmitter accepts;
the capacities and type of decoding that the receiver accepts;
the modes of coding/decoding that the transmitter/receiver uses.

Mode of coding, or coding (or encoding) strategy, is understood to mean notably the choice of implementation of the coding formed at the coder/decoder. By way of example, this may be an intra mode of coding, an intermode of coding of hierarchic P type (as defined in the document “H. 264 hierarchical P coding in the context of ultra-low delay, low complexity applications” Thomas Wiegand for example), an intermode of coding of IPPP (for “I picture, P picture, P picture, P picture”) type, an inter mode of coding of IPPPI (for “I picture, P picture, P picture, P picture, I picture”) type, a mode of coding of “skip” type, etc.

Following setup of the multimedia session, the quality of the video received by a customer (also called the user) may possibly be degraded, following a constriction on the network, a loss of data, or even limitation of processing capacity with the customer.

In order to continue the transmission of the sequence of pictures despite these modifications of the transmission conditions, existing video coders, notably based on the standards H.264, H.263, MPEG4, etc., accept the implementation of specific solutions involving:
a) reducing the quality of the video by increasing the compression of each picture;
b) producing the quality of the video by reducing the frequency of the pictures (“frame rate” in English);
c) keeping the same quality and requesting that a picture be sent in intra mode (raw picture without being encoded);
d) keeping the same quality and changing the coder/decoder.

A disadvantage of the first two proposed techniques a) and b) is that they reduce the quality of the video, which leads to degradation of the video received by the customer, in terms of the quality of the pictures or the fluidity of the pictures.

The last two proposed techniques c) and d) allow a constant video quality to be guaranteed when problems arising on the network become apparent.

However, if technique c) is applied following a drop in speed on the transport channels (thus bringing about a loss of data and hence degradation of the pictures), the implementation of this solution leads to accentuated degradation of the quality of the picture. This is because this solution involves sending a picture in intra mode, which contains all of the information from a picture and is therefore of large size, in a channel that is able to send only data of small size.

Technique d) involves changing video coder and choosing a new video coder, whose compression rate is higher, so that the speed of sending is suited to that of the transmission channel. A disadvantage of this technique is the additional cost of processing brought about by the decoder. The reason is that the implementation of technique d) requires the power of the processors, on the customer side, to be suited to the cost required by the new coder/decoder. If it is not suited, the implementation of this solution brings about accentuated degradation of the quality of the video, if the processor does not manage to process the computation requests made by the new coder/decoder, and the quality of the received picture (at the output of the video decoder) is degraded.

Finally, whatever the chosen mode of coding/decoding, degradation on one of the elements in the transmission chain (for example a reduction in speed) generally brings about more or less accentuated degradation of the quality of the video received by the customer.

There is therefore a need for a new transmission technique for a sequence of pictures that does not have all of the disadvantages of the prior art.

### 3. SUMMARY OF THE INVENTION

The invention proposes a solution to this problem in the form of a transmission method for a sequence of pictures comprising the following steps:
identification, in at least one picture in the sequence, of at least two separate regions;
for each of the regions, determination of a mode of coding that is suited to the region;
coding of the picture(s) by using, for each of the regions, the mode of coding that is suited to the region, and transmission in a single video stream.

Thus, the invention is based on a novel and inventive approach to the transmission of a sequence of pictures, allowing different coding of various regions or areas of the pictures. In this way, it is possible to use a more robust mode of coding for a region that has a high level of interest (notably from the point of view of the customer), and a less robust mode of coding for a region that has a low level of interest.

In particular, in equivalent transmission conditions, it is possible, according to the invention, to transmit a video stream that, from the point of view of the customer, has better quality than a video stream transmitting using a conventional technique. The reason is that, according to the prior art, all of the picture is coded by using a specific mode of coding, whereas according to the invention the regions that have a high level of interest are coded by using a more robust mode of coding and therefore appear to have better quality for the customer.

Moreover, in the event of degradation of the transmission conditions, the customer does not detect degradation of the picture because it is not, or not very, degraded for the region(s) in which he is interested (for example the center of the picture), even if it is degraded for the region(s) that are not of great interest (for example the background or the edges of the picture).

Furthermore, in the event of error in the course of the transmission, it is possible to return only the information associated with the region in which the error has occurred (for example in the form of a prediction residual or of the entire region in the form of an intra picture), which allows passband use to be limited. This is because a loss or error occurring in one region does not impact on the other regions, since the various regions are coded independently, by using separate modes of coding.

In particular, it is noted that the invention requires the use of a single coder (for example of H.263, H.264 or MPEG4 type, or of other, existing or future coders), which is able to implement various modes of coding or coding strategies on the various regions of a picture.

According to a specific aspect of the invention, the step of determination of a mode of coding that is suited to a region takes account of the content of the region.

By way of example, the step of determination takes account of an activity in the region.

Thus, if considering a sequence of pictures in which the first picture is made up of a figure and the background of an instant to, the second picture is made up of the same figure animated with a movement and of the same background at an instant t1 and the third picture is made up of the same figure animated with another movement and of the same background at an instant t2 then the pictures in the sequence of pictures will be able to be segmented into two regions in a similar manner, a first region corresponding to the figure and a second region corresponding to the background, and two separate modes of coding will be able to be assigned to these two regions.

The region corresponding to the figure in this example has a high level of activity (movement of the figure over three pictures) and therefore corresponds to a region that is important to the customer, who receives and shows the video. Therefore, according to the invention, a robust mode of coding is assigned to this region, which allows this region to be coded with good quality (for example as a mode of coding of hierarchic P type).

Conversely, the region corresponding to the background in this example does not have any, or little, activity, and therefore corresponds to a region of lesser interest to the customer. Therefore, according to the invention, a less robust mode of coding is assigned to this region, which allows this region to be coded with lower quality (for example as a mode of coding of IPPP type).

Thus, by way of example, within one and the same picture, some regions can therefore be coded as a picture of type I and others as a picture of type P.

The picture(s) coded by using, for each of the regions, the mode of coding that is suited to the region are then transmitted in a single video stream.

In particular, and as presented above, the mode of coding that is suited to a region is defined for a plurality of pictures in the sequence.

By way of example, the modes of coding belong to the group comprising:
coding of IPPP, or “I picture, P picture, P picture, P picture”, type,
coding of hierarchic P picture type,
coding of IPPPI, or “I picture, P picture, P picture, P picture, I picture”, type,
coding of adaptive intra refresh type (“AIR” in English);
coding of “backchannel” type, as described in the H.263 standard, for example.

Of course, this list is not exhaustive, and any mode of coding can be applied independently to each of the regions of a picture, for example according to the interest in the region. In particular, the examples of modes of coding that are proposed concern real time transmissions more specifically, but other modes of coding can be envisaged in the general case, notably with pictures of type B.

In particular, for a region of the picture that satisfies a particular interest criterion, the determined mode of coding is robust coding of hierarchic P or IPPPI picture type.

For a region of the picture that does not satisfy the particular interest criterion, the determined mode of coding is of IPPP type.

According to another aspect of the invention, the transmission method comprises a prior step of determination of the transmission parameters of the sequence of pictures.

Thus, a first set of transmission parameters, for example defining the frequency of transmission of the pictures, the resolution of the pictures, the transmission speed, etc., can be negotiated/defined prior to the transmission, when a multimedia session is opened.

Once this first set of parameters has been defined, a second “set of parameters” that are specific to the coder is considered, for example defining the various modes of coding/decoding that are authorized by the coder and the decoder. These modes of coding/decoding are notably dependent on the transmission parameters defined in the first set (such as the frequency of transmission of the pictures, the resolution, etc., which are predefined).

According to one particular aspect of the invention, the transmission method comprises a step of updating of the regions and of the modes of coding that are suited to each of the regions, which is periodic and/or takes account of modification of the transmission channel.

Thus, it is possible to redefine the regions and/or the mode of coding that is used for each region in the course of the transmission, periodically and/or as a function of a variation in the transmission channel. The adaptive scheme proposed according to this embodiment allows the coding of the sequence of pictures to be optimized.

By way of example, this updating step can be carried out on reception, by the coder, of a piece of information on the transmission channel (“feedback”).

According to another particular feature of the invention, at least one indicator can be inserted into the video stream so as to identify the various regions of the picture and/or to specify the mode of coding used for each region.

In another embodiment, the invention concerns a transmission device for a sequence of pictures, comprising:
means for identification, in at least one picture in the sequence, of at least two separate regions;
means for determination of a mode of coding that is suited to each of the regions;
means for coding of the picture(s) by using, for each of the regions, the mode of coding that is suited to the region, and means for transmission in a single video stream.

Such a transmission device is notably suited to implementing the transmission method described above. By way of example, it comprises a video coder of H.263, H.264, MPEG4, etc., type.

This device will of course be able to have the various features relating to the transmission method according to the invention, which can be combined or taken in isolation. Thus, the features and advantages of this device are the same as those of the transmission method, and are not specified in more detail.

The invention furthermore concerns a reception method for a sequence of pictures, comprising the following steps:
reception of a single video stream, comprising at least one picture coded by using a mode of coding that is suited to each region of the picture(s);
decoding and restoration of the picture(s).

Such a method is notably suited to receiving a video stream as described above. This method will therefore be able to have the various features relating to the transmission method according to the invention. Thus, the features and advantages of this reception method are the same as those of the transmission method, and are not specified in more detail.

In another embodiment, the invention concerns a reception device for a sequence of pictures, comprising:
means for reception of a single video stream, comprising at least one picture coded using a mode of coding that is suited to each region of said at least one picture;
means for decoding and restoration of the coded picture(s).

Such a reception device is notably suited to implementing the reception method described above. By way of example, it comprises a video decoder of H.263, H.264, MPEG4, etc., type.

This device will of course be able to have the various features relating to the reception method according to the invention, which can be combined or taken in isolation. Thus, the features and advantages of this device are the same as those of the reception method, and are not specified in more detail.

In another embodiment, the invention concerns one or more computer programs having instructions for implementing a transmission method and/or a reception method as described above when this or these program(s) are executed by a processor.

Thus, the transmission and/or reception methods according to the invention can be implemented in various ways, notably in wired form or in software form.

In yet another embodiment, the invention concerns at least one computer-readable recording medium on which is recorded a computer program comprising computer-executable instructions for implementing a transmission method and/or a reception method as described above.

### 4. LIST OF FIGURES

Other features and advantages of the invention will emerge more clearly upon reading the description that follows for a particular embodiment, provided by way of simple illustrative and non-limiting example, and the appended drawings, in which:

FIG. 1 shows the principal steps of a transmission method according to a particular embodiment of the invention;

FIG. 2 shows the principal steps of a reception method according to a particular embodiment of the invention;

FIG. 3 illustrates an example of processing of a picture in a sequence of pictures according to a particular embodiment of the invention;

FIGS. 4 and 5 show the structure of a transmission device and of a reception device, respectively, according to a particular embodiment of the invention.

### 5. DESCRIPTION OF AN EMBODIMENT OF THE INVENTION

### 5.1 General Principle

The general principle of the invention is based on the identification of various regions in at least one picture in a sequence of pictures, and on the specific coding of these various regions, by using a mode of coding that is suited to each region. Such a mode of coding is selected from a set of modes of coding that is defined for the coder that is used. Thus, it is possible to use a first mode of coding in order to code a first region of the picture, a second mode of coding in order to code a second region of the picture, etc. The picture(s) coded in this manner by the coder are transmitted in a single video stream.

It is thus possible to maintain the quality of the video that is perceived by a customer even in the event of modification of the transmission conditions, or even to improve the quality of the video perceived by a customer in relation to existing transmission techniques under the same transmission conditions.

In particular, it is possible to limit the degradation of the quality of the video perceived by a customer or user, notably in the event of reduction of the capacity of the channel, by adapting the mode of coding to the various regions of the picture, and by taking account of the regions of interest in the pictures, for example.

### 5.2 Description of Particular Embodiments

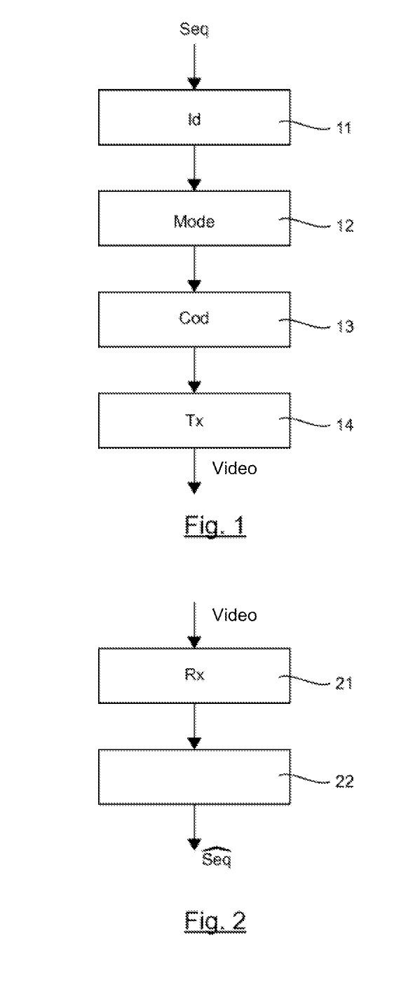

The principle steps of a transmission technique for a sequence of pictures Seq according to a particular embodiment of the invention are presented with reference to FIG. 1.

In the course of a first step 11, at least two separate regions are identified (Id) in at least one picture in the sequence Seq.

According to the embodiment of the invention, the identification of various regions in a picture can be implemented statically or dynamically, and manually or automatically.

By way of example, according to a first variant, known as static, it is possible to predetermine, as a function of the video stream to be transmitted, that some regions of the picture (for example the edges, the corners) are of lesser interest to the user and are therefore processed as regions for which the quality can be degraded by using a basic mode of coding. By inference, the other regions of the picture, for example the center, are considered to be of great interest by the customer, and are therefore processed as regions for which it is necessary to preserve the quality by using a robust mode of coding.

Thus, if the video stream contains fixed scenes instead, for example in the case of a video conference session with static speakers, the regions can be predefined.

According to a second variant, known as dynamic, the various regions are not predefined prior to the transmission.

By way of example, it is possible to use known techniques for looking for movement in order to attribute greater importance to active regions, having movement, to the detriment of regions that do not have any movement, and are therefore static.

It is furthermore possible to segment the pictures in the sequence of pictures manually, or automatically by using a known technique, of flexible macroblock ordering (FMO in English) type, for example.

In the course of a second step 22, a mode of coding that is suited to the region is determined for each of the regions.

It will be recalled that any mode of coding that is compatible with the coder used can be applied independently to each of the regions, according to the interest in the region, on the basis of this particular embodiment. Such a mode of coding or coding algorithm notably allows an improvement in the quality and/or the resistance to losses.

It is thus possible to assign, according to this particular embodiment, different modes of coding within one and the same picture, by choosing a mode of coding that is suited to the activity in the corresponding region. Thus, the proposed solution, according to this embodiment, allows nonuniform degradation of the sequence of pictures in the event of a reduction in the capacity of the channel, whereas existing solutions are based on equivalent degradation (over the whole picture) of the sequence of pictures. The proposed solution therefore allows, according to this particular embodiment, greater degradation of the pictures in the sequence in the regions in which the quality perceived by the customer is of little interest, and preservation of maximum quality in the regions in which the quality perceived by the customer is paramount.

In this way, it is possible to preserve the quality of a region of interest within a video stream, or to limit the degradation so that it is not perceived by the customer, in an environment that is constrained in terms of data transmission capacity.

By way of example, if the region is of little interest, a mode of coding that does not retransmit this region of the picture in the event of error is chosen. Notably, if it is a “background” region of the picture, that is to say one that does not change in the sequence of pictures, it is possible to choose a “skip” type mode of coding, thus corresponding to an absence of transmission of information representative of this region. Conversely, if the region has a high level of interest, it is possible to choose a mode of coding that resends the Ipicture.

In the course of a third step 13, the picture(s) in the sequence are coded, by using, for each of the regions, the mode of coding that is suited to the region determined in the preceding step. A single video stream is generated in the course of this third step.

It will be noted that these first three steps 11, 12 and 13 can be implemented by a coder, such as an H.263, H.264, MPEG4, etc., coder, for example.

In the course of a fourth step 14, the video stream is transmitted to a customer.

Henceforth, the principal steps of a reception technique for a video stream according to a particular embodiment of the invention will be described with reference to FIG. 2.

In the course of a first step 21, a video stream comprising at least one picture coded by using a mode of coding that is suited to each region of the picture(s) is received, which is obtained as described above.

In the course of a second step 22, the coded picture(s) are decoded, and the corresponding sequence of pictures Seq is restored on a terminal of the customer.

Various decoding options can be envisaged, implementing either a conventional decoder or separation of the data in the video stream as a function of the region of the picture so as to submit each region of the picture to a decoder that is suited to the mode of coding used for the corresponding region.

In particular, according to the prior art, a picture could be restored or refreshed at the customer terminal only once the information representative of the whole picture had been received and decoded. According to the invention, it is possible to restore/refresh a region of the picture (for example a region of interest, in which there is more movement) as soon as the information representative of this region of the picture has been received and decoded.

### 5.3 Examples of Implementation of the Invention

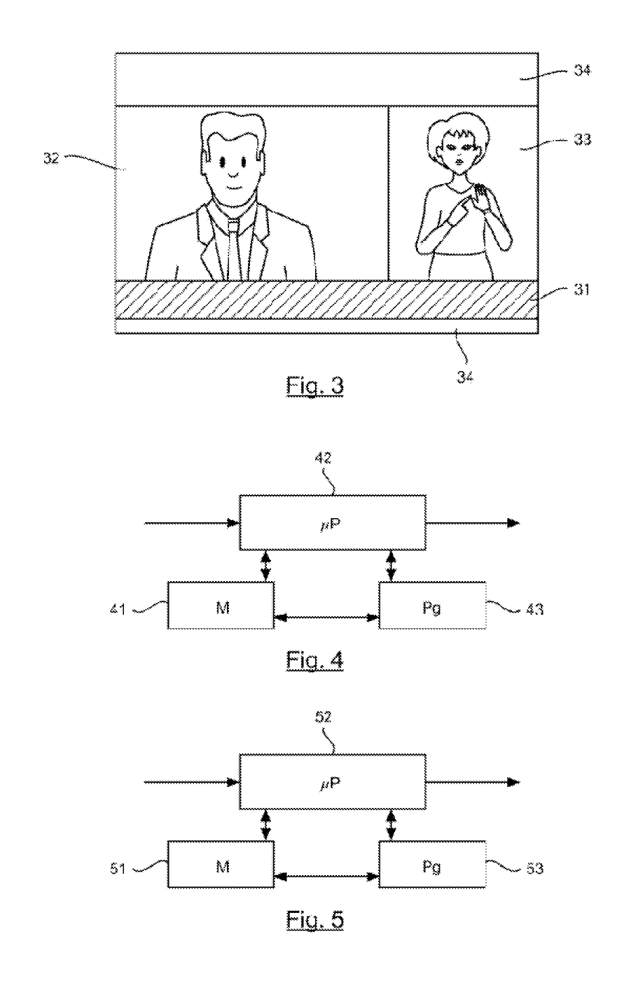

Henceforth, a first example of an implementation of the invention will be presented with reference to FIG. 3.

By way of example, a sequence of pictures that is representative of television news, in which the scene is made up of the background merged with a change of luminosity, the presenter and a special correspondent, and an area at the foot of the scene indicating stock exchange prices or an information banner, will be considered.

According to a particular embodiment of the invention, a picture at an instant t is broken down into four regions:
a region 31, hatched, indicating the stock exchange prices or an information banner;
a region 32 that corresponds to the area of movement by the presenter;
a region 33 that corresponds to the area of movement by the special correspondent; and
a region 34 representing the background.

In the event of degradation of the transmission conditions, and notably of the transmission channel, instead of reducing the quality of the video by reducing the frequency of the pictures to 25 pictures per second over the whole picture, for example, it is proposed according to the invention to keep this frequency at 50 pictures per second and to apply a different mode of coding to the various regions of the picture:
over the region 33 containing the special correspondent, which corresponds to the greatest priority area from the point of view of the customer: application of a mode of coding of hierarchic P type, or else a mode of coding of I, P, I, P, etc. type (in other words, the picture is sent within this region half the time: with the first picture, with the third picture, with the fifth picture, etc.);
over the region 32 containing the presenter, which corresponds to a normal priority area from the point of view of the customer: application of a conventional mode of coding, for example of I, P, P, P, P, I type (in other words, the picture is sent within this region once in five times: with the first picture, with the sixth picture, etc.);
over the region 31 containing the information banner or the stock exchange prices, which corresponds to a low priority area from the point of view of the customer: application of a less robust mode of coding, for example of I, P, P, P, P, P, P, P, P, P, I type (in other words, the picture is sent within this region once in ten times: with the first picture, with the eleventh picture, etc.). It is likewise possible to choose a mode of coding that does not retransmit the region of the picture (or a residual corresponds to this region of the picture) in the event of loss of data;
over the region 34 containing the background/rest of the picture: application of an even less robust mode of coding. Notably, when the rest of the picture is fixed, it is possible to use the “skip” mode of coding as soon as the quality of the background restored to the customer is sufficient. By way of example, the picture is sent within this region a single time, and then this region is no longer coded while there is no change to the level of the background. In particular, it is possible to choose a mode of coding that does not allow any retransmission in the event of error or loss of data. Thus, in the event of an error, no update to the background is required, in as much as this region is of little interest to the customer.

Thus, according to at least one of its embodiments, the invention allows the degradation perceived by the customer/user to be limited in the event of degradation of the transmission conditions, since the special correspondent and the presenter remain fluid and well defined, and the information banner/stock exchange prices remain(s) legible (albeit of lesser quality than the special correspondent and the presenter). It will be recalled that according to the techniques of the prior art the picture is degraded overall.

According to a second example of an implementation of the invention too, a video conference session will be considered, the incoming speed of which in the video conference server is limited to 2 Mbs. The outgoing speed, at each of the participants, is dependent on the number of participants in this video conference. By way of example, if the number of participants is equal to 5, then each of the participants has an average of 400 kbs, and the transmission quality of the video from each participant is then limited by this speed. Furthermore, if the number of participants increases, and notably if it doubles (10 participants), the speed allocated to each participant is divided by two, that is to say 200 kbs, and the quality of the video transmitted by each of the participants is degraded, in a manner that is uniform for the whole picture according to the known techniques of the prior art.

Conversely, according to a particular embodiment of the invention, the picture from each participant is segmented into two different regions: a first region for the face and a second region for the background. Each of these regions takes a portion of the allocated speed of 200 kbs, and a separate mode of coding is assigned to each of these regions, depending on the interest associated with each region.

Thus, if the speed used by the face region, while preserving the other original transmission parameters (size and frequency of pictures), is lower than 200 kbs (150 kbs, for example), then no change of quality will be applied to this region (a conventional mode of coding is preserved, or a more robust mode of coding is used in order to improve the quality of the face region, such as coding of AIR or IPPPI type). The rest of the speed (50 kbs) is then allocated to the region of the background, for which a less robust mode of coding is used, such as IPPP coding.

If the speed used by the face region, while preserving the other original transmission parameters (size and frequency of pictures), is higher than 200 kbs (250 kbs, for example), then the mode of coding is modified in order to use a mode of coding that uses less passband, such as coding of hierarchic P type, so as to use only a portion of the speed, for example 150 kbs. The rest of the speed (50 kbs) can then be allocated to the region of the background, for which a less robust mode of coding is used, such as IPPP coding. At the decoder end, a region of lesser interest to the customer is therefore refreshed less often.

By way of example, if realtime applications are considered, it is possible for various modes of coding to be classified as a function of their cost in terms of speed, from less costly to the most costly: coding of IPPP type, coding of hierarchic P type, coding of “backchannel” type, coding of AIR type, coding of IPPPI type.

Finally, the two regions are transmitted in a single video stream.

This processing, according to this embodiment of the invention, gives rise to a loss of quality over the region corresponding to the background, which does not disturb the user, since the background does not move or does not move very much, but the quality of the face region is preserved (or even improved). Thus, the degradation in the quality of the picture owing to a reduction in the transmission speed is not perceived by the user.

5.4 Simplified Structures of a Transmission Device and of a Reception Device

FIG. 4 shows the simplified structure of a transmission device implementing the transmission method according to a particular embodiment of the invention.

This device comprises a RAM memory 41, a processing unit 42, for example equipped with a processor, and controlled by a computer program stored in a ROM memory 43. On initialization, the code instructions of the computer program are loaded into the RAM memory 41, for example, before being executed by the processor of the processing unit 42. The processing unit 42 receives as input at least one picture in a sequence of pictures. The processor of the processing unit 42 implements the steps of the transmission method described above, according to the instructions of the computer program 43, by applying separate processing to the various regions of the picture(s), and generates a single video stream as output, comprising at least one picture coded by using a mode of coding that is suited to each region of the picture(s). For this, the transmission device comprises, apart from the memory 41, means for identifying, in at least one picture in the sequence, at least two separate regions, means for determining a mode of coding that is suited to each of the regions, means for coding the picture(s) and means for transmission in a single video stream. These means are controlled by the microprocessor of the processing unit 42.

FIG. 5 shows the simplified structure of a reception device implementing the reception method according to a particular embodiment of the invention.

This device comprises a RAM memory 51, a processing unit 52, for example equipped with a processor, and controlled by a computer program stored in a ROM memory 53. On initialization, the code instructions of the computer program are loaded into the RAM memory 51, for example, before being executed by the processor of the processing unit 52. The processing unit 52 receives a single video stream as input. The processor of the processing unit 52 implements the steps of the reception method described above, according to the instructions of the computer program 53, in order to decode and restore the picture(s) coded by using a mode of coding that is suited to each region of the picture(s). For this, the reception device comprises, apart from the memory 51, means for receiving a single video stream, comprising at least one picture coded by using a mode of coding that is suited to each region of the picture(s), and means for decoding and restoring the picture(s). These means are controlled by the microprocessor of the processing unit 52.

According to various embodiments, the invention is implemented by means of software and/or hardware components.

A software component corresponds to one or more computer programs, one or more subroutines of a program or, more generally, to any element of a program or a piece of software that is able to implement a function or a set of functions. Such a software component is executed by a data processor of a physical entity (coder, transmitter, terminal, decoder, receiver, transmission device, reception device, etc.) and is capable of accessing the hardware resources of this physical entity (memories, recording media, communication buses, electronic input/output cards, user interfaces, etc.).

In the same way, a hardware component corresponds to any element of a hardware assembly capable of implementing a function or a set of functions. It may be a programmable hardware component or one with an integrated processor for executing software, for example an integrated circuit, a chip card, a memory card, an electronic card for executing firmware, etc.

1. A transmission method for a sequence of pictures, characterized in that it comprises the following steps:
identification (11), in at least one picture in said sequence, of at least two separate regions;
for each of said regions, determination (12) of a mode of coding that is suited to said region;
coding (13) of said at least one picture by using, for each of said regions, the mode of coding that is suited to said region, and transmission (14) in a single video stream.

2. The transmission method as claimed in claim 1, characterized in that said step of determination (12) takes account of the content of said region.

3. The transmission method as claimed in claim 2, characterized in that said step of determination (12) takes account of an activity in said region.

4. The transmission method as claimed in claim 1, characterized in that said mode of coding that is suited to a region is defined for a plurality of pictures in said sequence.

5. The transmission method as claimed in claim 1, characterized in that said modes of coding belong to the group comprising:
coding of IPPP, or “I picture, P picture, P picture, P picture”, type,
coding of hierarchic P picture type,
coding of IPPPI, or “I picture, P picture, P picture, P picture, I picture”, type,
coding of adaptive intra refresh type.

6. The transmission method as claimed in claim 5, characterized in that, for a region of the picture that satisfies a particular interest criterion, the determined mode of coding is of hierarchic P or IPPPI picture type.

7. The transmission method as claimed in claim 1, characterized in that it comprises a prior step of determination of the transmission parameters of said sequence of pictures.

8. The transmission method as claimed in claim 1, characterized in that it comprises a step of updating of said regions and of said modes of coding that are suited to each of said regions, which is periodic and/or takes account of modification of the transmission channel.

9. A transmission device for a sequence of pictures, characterized in that it comprises:
means for identification (11), in at least one picture in said sequence, of at least two separate regions;
means for determination (12) of a mode of coding that is suited to each of said regions;
means for coding (13) of said at least one picture by using, for each of said regions, the mode of coding that is suited to said region, and means for transmission (14) in a single video stream.

10. A reception method for a sequence of pictures, characterized in that it comprises the following steps:
reception (21) of a single video stream, comprising at least one picture coded by using a mode of coding that is suited to each region of said at least one picture;
decoding (22) and restoration of said at least one picture.

11. A reception device for a sequence of pictures, characterized in that it comprises:
means for reception (21) of a single video stream, comprising at least one picture coded using a mode of coding that is suited to each region of said at least one picture;
means for decoding (22) and restoration of said at least one picture.

12. A computer program having instructions for implementing a method as claimed in claim 1 when this program is executed by a processor.

13. A computer-readable recording medium on which is recorded a computer program comprising computer-executable instructions for implementing a method as claimed in claim 1.

14. A computer program having instructions for implementing a method as claimed in claim 10 when this program is executed by a processor.

15. A computer-readable recording medium on which is recorded a computer program comprising computer-executable instructions for implementing a method as claimed in claim 10.
